(19) United States
(12) Patent Application Publication
(10) Pub. No.: US 2008/0017125 A1
(43) Pub. Date: Jan. 24, 2008

(54) Culture tank for marine organisms

(76) Inventor: Robert M. Power, Norwich (GB)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/820,967

(22) Filed: Jun. 21, 2007

Related U.S. Application Data
(60) Provisional application No. 60/815,639, filed on Jun. 22, 2006.

(51) Int. Cl. A01K 61/00

(52) U.S. Cl. 119/200

(57) ABSTRACT

The present invention is directed to a culture tank for marine organisms, having a water tank, an overflow sill with an algae scrub and an optional cover. The culture tank provides an environment capable of culturing both the target marine organism and secondary organisms, simultaneously.

### CROSS-REFERENCE TO RELATED APPLICATIONS

This application claims priority to U.S. Provisional Application No. 60/815,639, filed Jun. 22, 2006, the disclosure of which is hereby incorporated by reference in its entirety.

### BACKGROUND OF THE INVENTION

Most of the world's fisheries are threatened by unsustainable fishing practices and pressures. Many fisheries target the adult life phase of the target species as the commercial resource. This is economically effective as long as fishing systems and pressure do not jeopardize the biological integrity of the wild stocks of the target species. However, with many species of marine organism, the individuals that live long enough to become adults numerically represent only a very small percentage of the reproductive effort of the wild population. This small percentage is a result of high mortality rates which occur during the early stages of growth development of the species.

One manner in which to harvest target species without the negative effects associated with fishing for adult life phase organisms is aquaculture. Aquaculture is the cultivation of aquatic organisms, e.g., fish, shellfish, algae (algaculture), etc. Also known as aquafarming, aquaculture is distinguished from fishing in that aquaculture consciously maintains and potentially increases the natural supply of the target organisms, as opposed to common fishing practices which simply depletes the number of target organisms.

Aquaculture typically uses land based tanks as the basis for farming systems. The dimensions of tanks used, the construction and the design of tanks are usually defined by economic consideration. These considerations include the tank foot print and shape, especially in places where space is at a premium; construction cost of the tanks themselves, particularly when large volumes of water are necessary; choice of construction materials, taking into account whether the target organism is sensitive to small shifts in water chemistry; tank/water depth where specific aspects of the target organism biology define the depth of water in which they are reared.

Most aquaculture operations focus on one target species and are designed solely with the aim of ensuring maximum production of the one target. Increasingly aquaculture systems designers are also looking at the waste products of the target species cultured and devising ways to minimise pollution from these systems. Minimising pollution often involves incorporating a biological filtration component into the culture system, as these have proven to be more effective than other forms of filtration under certain conditions.

Numerous researchers and aquaculture professionals have discussed biofiltration systems that minimise pollution, as well as culture more than a single target species. For example, U.S. Pat. No. 4,394,846 to Roels, the disclosure of which is hereby incorporated by reference, describes an ocean water system designed to apply the biofiltration concept to culture of multiple target species in successive tank based stages. The initial target species is maintained with a processed feed and each successive species benefits from the by products of the culture from the preceding stage, supplemented by additional feed where necessary.

Although the sequence of species and species groups, reared in successive tanks within a general aquaculture set up may address the pollution issue, it has several economic drawbacks for commercial use, e.g., the cost of maintaining the successive tanks and disadvantage of rearing only one species at a time.

The tank of the present invention incorporates the principles of biofiltration and the potential for the culture of a secondary species within a single tank at the same time, which is advantageous both practically and economically for commercial fisheries.

### SUMMARY OF THE INVENTION

The present invention is directed to a culture tank for marine organisms, having a water tank, an overflow sill with an algae scrub and an optional cover. The culture tank provides an environment capable of culturing both the target marine organism and secondary organisms, simultaneously.

In certain embodiments, the present invention is directed to a culture tank for marine organisms comprising: a water tank having a base, an open top, and sides running the periphery of the base; an overflow sill connected to and running the length of a side of the open top of the tank; and an algae scrub located on the overflow sill.

In other embodiments, the present invention is directed to methods for the culture of marine organisms comprising: inserting a marine organism(s) into a culture tank as described above, and allowing sufficient time for the marine organism(s) to grow to their desired growth stage.

In yet other embodiments, the present invention is directed to methods for the simultaneous culture of at least two marine organisms comprising: inserting a primary marine organism into a culture tank, wherein the culture tank comprises: a water tank having a base, an open top, and sides running the periphery of the base; an overflow sill connected to and running the length of a side of the open top of the tank; an algae scrub located on the overflow sill; and at least one optionally removable mesh panel connected to the base of the tank in front of the overflow sill; encrusting the mesh panel with at least one secondary organism; and allowing sufficient time for the primary and secondary organisms to grow to their desired growth stage.

### BRIEF DESCRIPTION OF THE DRAWINGS

FIG. 1 depicts one embodiment for the tank design. Annotation A indicates a central channel in the bottom of the tank. B indicates the slope of the bottom of the tank from the sides to the central channel. C indicates the overflow sill structure along one edge of the tank. Annotation D indicates a likely location for a retaining screen.

### DETAILED DESCRIPTION OF THE PREFERRED EMBODIMENTS

The tank of the present invention has many advantages over previous tanks in that it incorporates a special structure which acts as a shallow water refuge for target culture organisms, provides biological filtration for the outgoing waste water and provides habitat for a secondary culture species, within the same tank unit.

The tank of the present invention consists of a water tank and an overflow sill with an algae scrub, and an optional cover. The water tank can be of any shape suitable for holding water, e.g., rectangular, oval, etc., and have a capacity for use in small scale operations (e.g., 50 gallon capacity) or large industrial application (e.g. 1,500 gallon capacity). The shape and the capacity of the tank is an important aspect, as it is necessary to control the separation of the produce (target species) into manageable compartments and to restrict possible disease contamination into smaller segments of the produce. The produce, or target species, may include for example, lobsters (Palinuridae), welks (Cittarium pica), oysters (Pinctada Spp.), abalone, amphipods, goose barnacles, and the like. In most preferred embodiments, the tank is rectangular and has about a 200-800 gallon capacity, however one skilled in the art would appreciate the most suitable tank shape and capacity based on their individual need.

Another important aspect of the tank is the tank depth. Tank depth should be considered for water turnover rate and ambient gas exchange. Higher surface area to volume ratio helps optimise natural degassing and absorption of ambient gases. Synergistic effects of tank design features and active systems to ensure optimum water quality (such as aeration and water flow rate) help to reduce energy requirements of active systems and safeguard livestock in the event of multiple system failure. Lower volume tanks also allow far greater relative water exchange rates which prevent build up of toxic compounds, allow effective biofiltration by comparatively small surface areas of biofilter, and reduce the pumping and sterilisation energy required to achieve optimum conditions. In preferred embodiments, the depth of the tank is less than 200 cm, and in most preferred embodiments, the depth of the tank is less than 120 cm. Tanks may be made from any material suitable for rearing the target marine organisms. In preferred embodiments, the tank material is a UV resistant combination of plastic polymer, fibreglass and resin or water proof, reinforced concrete Styrofoam mixture.

The overflow sill of the tank is the primary nutrient scrub surface on the outflow of the tank. Maximum surface area of the sill affords maximum absorption of nutrients/pollutants by algae that is colonising on the sill. The sill also affords a surface for grazing of secondary species and an ideal moulting refuge for lobsters approaching ecdisis. For example, most lobsters will avoid exceptionally shallow water, but moulting lobster actively seek out solitary areas to complete ecdisis (moulting) unmolested. The slope of the sill is designed to simulate natural shallow water habitats. The range of sill length encompasses the minimum and maximum operationally convenient sill width. In preferred embodiments, the sill has variable dimensions; preferably less than 40 cm width, and about 2 to 16 cm in depth, running the length of one of the sides of the container (or a portion of the container if the container shape is, e.g., round or oval), such that the overflow water from the tank passes over this sill.

An algae scrub is included on the overflow sill to help extract excess nutrients/waste products of the culture process. The algae scrub also has the added function of simulating natural intertidal action where moulting animals may seek shelter and providing grazing for marine gastropods that offer economic potential as secondary products and aid in the culture process. As water flows past the algae colonised on the sill, the algae absorbs various dissolved compounds necessary in the synthesis of proteins. This process can significantly reduce the levels of nitrogen-based compounds in the water. The algae scrub may be comprised of any algae or mixture of algae compatible with the target species. Preferably, the algae selected is capable of rapid growth and has structural complexity to sufficiently retard water flow across the overflow sill, enabling maximum absorption of nutrients from the water. Structurally complex algae also provides a habitat that encourages the culture of grazing amphipods and gastropods.

In preferred embodiments, the tank also has a central channel recessed into the bottom, running the length of the tank. Movement of water within the tank will encourage solid waste to accumulate in the channel, thus facilitating cleaning. Additionally, a valve may be placed at the end of the channel to further facilitate cleaning. In more preferred embodiments, the bottom of the tank has a negative slope from the sides of the tank to the edge of the channel. In most preferred embodiments, the bottom of the tank has a slope of up to 8°.

In other preferred embodiments, secondary organisms may be cultured simultaneously with the target organism by inserting panel(s) of mesh encrusted with the secondary organisms. The mesh panels are incorporated in close proximity to the overflow sill to filter out suspended solids through their filter feeding, and are optionally removable. In more preferred embodiments, two or more mesh panels may be arranged consecutively, e.g., at about 3-10 cm apart, in order to accommodate various species of secondary organisms. The secondary organisms strip the suspended solids from the water and the algae sill strips the dissolved nutrients. In addition to their filtering capability, the inclusion of secondary organisms also act as a distraction to the primary target species, to prevent aggressive interactions between the individual primary target species, as well as providing economic benefits resulting in the simultaneous culture of multiple organisms.

In preferred embodiments, secondary organisms cultured in the tank of the present invention include any marine organism capable of being encrusted onto the mesh panel. Examples of secondary organisms which may be used in the present invention include, but are not limited to, aquatic gastropods (e.g., snails), bivalves (e.g., oysters such as Pinctada imbricata or similar bivalves), species of Porifera, amphipod species, coral reef fish, etc. In most preferred embodiments, pearl oysters are used because of their added benefit as a potentially lucrative extra product.

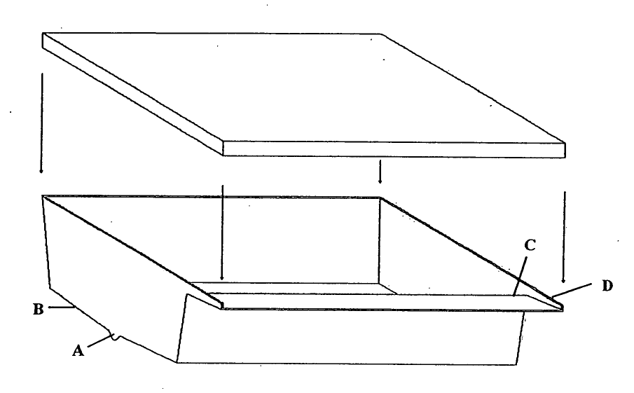

In preferred embodiments, the tank of the present invention further comprises a retaining screen to prevent target organisms from exiting the tank. The retaining screen comprises apertures which are preferably between about 6 mm and 20 mm in size. In more preferred embodiments, the retaining screen is made of a plastic mesh material, although those of skill in the art would recognize other materials which would be suitable for use. In most preferred embodiments, the retaining screen is arranged vertically, running the length of the tank, as suggested in FIG. 1, annotation D.

Water may be pumped in along the bottom wall of the tank opposite the sill. It then flows through the tank and out over the sill. However, one of skill in the art would recognise other ways in which water may be pumped throughout the tank. In preferred embodiments, each tank is fitted with aeration systems that create a bubble curtain at the sill side edge of the tank. This ensures aeration if water flow is reduced or stopped for any reason and it also acts as a behavioural screen to protect moulting target species and, if used, the mesh panels. In embodiments where the tank comprises mesh panels, the panels are preferably situated between the overflow sill and the bubble curtain.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A culture tank for marine organisms comprising:
a. a water tank having a base, an open top, and sides running the periphery of the base;
b. an overflow sill connected to and running the length of a side of the open top of the tank; and
c. an algae scrub located on the overflow sill.

2. The culture tank of claim 1, further comprising a removable cover.

3. The culture tank of claim 1, further comprising an optionally removable mesh panel(s) encrusted with at least one secondary organism, and connected to the base of the tank in front of the overflow sill.

4. The culture tank of claim 1, further comprising a channel running the length of the base of the tank for collecting solid waste, and a valve at one end of the channel for waste removal.

5. The culture tank of claim 1, further comprising an aeration system that discharges air into the tank in front of the overflow sill.

6. The culture tank of claim 1, wherein the bottom of the base is sloped downward, from the sides of the base to the center of the base.

7. A method for the culture of marine organisms comprising:
a. inserting a marine organism(s) into a culture tank, wherein said culture tank comprises:
i. a water tank having a base, an open top, and sides running the periphery of the base;
ii. an overflow sill connected to and running the length of a side of the open top of the tank;
iii. an algae scrub located on the overflow sill; and
b. allowing sufficient time for the marine organism(s) to grow to their desired growth stage.

8. The method of claim 7, wherein the tank further comprises at least one optionally removable mesh panel connected to the base of the tank in front of the overflow sill, wherein the mesh panel is encrusted with at least one secondary organism.

9. A method for the simultaneous culture of at least two marine organisms comprising:
a. inserting a primary marine organism into a culture tank, wherein said culture tank comprises:
i. a water tank having a base, an open top, and sides running the periphery of the base;
ii. an overflow sill connected to and running the length of a side of the open top of the tank;
iii. an algae scrub located on the overflow sill; and
iv. at least one optionally removable mesh panel connected to the base of the tank in front of the overflow sill
b. encrusting the mesh panel with at least one secondary marine organism; and
c. allowing sufficient time for the primary and secondary marine organisms to grow to their desired growth stage.
